(19) United States
(12) Patent Application Publication
(10) Pub. No.: US 2026/0280776 A1
(43) Pub. Date: Sep. 17, 2026

(54) RESOURCE INDICATION AND DETERMINATION FOR FEEDBACK TRANSMISSIONS

(71) Applicant: Lenovo (United States) Inc., Morrisville, NC (US)

(72) Inventors: Alexander Golitschek Edler von Elbwart, Darmstadt (DE); Joachim Löhr, Wiesbaden (DE); Prateek Basu Mallick, Dreieich (DE)

(73) Assignee: Lenovo (United States) Inc., Morrisville, NC (US)

(21) Appl. No.: 19/462,832

(22) Filed: Jan. 28, 2026

(51) Int. Cl. H04L 1/1867; H04L 1/00; H04L 5/00; H04W 74/0833

(52) U.S. Cl. CPC H04L 1/1896; H04L 1/0061; H04L 5/0044; H04W 74/0833

(57) ABSTRACT

Various aspects of the present disclosure relate to resource indication and determination for HARQ feedback transmission. An apparatus, such as a user equipment (UE), receives downlink control information (DCI) that indicates one or more resources for uplink transmission of hybrid automatic repeat request (HARQ) feedback associated with a downlink transmission. The DCI includes additional information associated with the uplink transmission of the HARQ feedback, such as when to transmit the HARQ feedback. The UE determines a resource of the one or more resources for the uplink transmission of the HARQ feedback based on the DCI and transmits the HARQ feedback on the resource of the one or more resources.

### TECHNICAL FIELD

The present disclosure relates to wireless communications, and more specifically to resource indication and determination for hybrid automatic repeat request (HARQ) feedback transmissions.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive downlink control information (DCI) that indicates one or more resources for uplink transmission of HARQ feedback associated with a downlink transmission, determine a resource of the one or more resources for the uplink transmission of the HARQ feedback based on the DCI, and transmit the HARQ feedback on the resource of the one or more resources.

A processor (e.g., a standalone processor chipset, or a component of a UE) for wireless communication is described. The processor may be configured to, capable of, or operable to perform one or more operations as described herein. For example, the processor may be configured to, capable of, or operable to receive DCI that indicates one or more resources for uplink transmission of HARQ feedback associated with a downlink transmission, determine a resource of the one or more resources for the uplink transmission of the HARQ feedback based on the DCI, and transmit the HARQ feedback on the resource of the one or more resources.

A method performed or performable by a UE for wireless communication is described. The method may include receiving DCI that indicates one or more resources for uplink transmission of HARQ feedback associated with a downlink transmission, determining a resource of the one or more resources for the uplink transmission of the HARQ feedback based on the DCI, and transmitting the HARQ feedback on the resource of the one or more resources.

In some implementations of the UE, the processor, and the method described herein, the DCI includes a field that indicates which of the one or more resources to use for the uplink transmission of the HARQ feedback, and the UE, the processor, and the method may further be configured to, capable of, or operable to determine the resource based on the field. In some implementations, the DCI indicates a threshold time after reception of the DCI or reception of a physical downlink shared channel (PDSCH) transmission until which to transmit the HARQ feedback. In some implementations, the DCI indicates to transmit the HARQ feedback on a resource associated with a physical uplink shared channel (PUSCH), where the resource is at least a number of time units after reception of the DCI or reception of a PDSCH transmission. In some implementations, the UE, the processor, and the method may further be configured to, capable of, or operable to transmit a scheduling request (SR) or a random access channel (RACH) transmission in response to the resource that is at least the number of time units after the reception of the DCI or the reception of the PDSCH transmission being unavailable.

In some implementations, the DCI indicates whether to transmit the HARQ feedback on a physical uplink control channel (PUCCH) or a PUSCH. In some implementations, the DCI includes timing information for the uplink transmission of the HARQ feedback, where the timing information indicates whether to transmit the HARQ feedback on the PUCCH or the PUSCH. In some implementations, the DCI indicates to protect the uplink transmission of the HARQ feedback by a cyclic redundancy check (CRC). In some implementations, the UE, the processor, and the method may further be configured to, capable of, or operable to map bits of the HARQ feedback to a subset of bits of a modulation symbol, and the HARQ feedback is transmitted using one or more bits based on the mapping. In some implementations, the UE, the processor, and the method may further be configured to, capable of, or operable to refrain from using the resource in an absence of the HARQ feedback associated with the downlink transmission.

In some implementations, the DCI indicates that the one or more resources support transmission of one or more logical channels (LCHs) or one or more logical channel groups (LCGs). In some implementations, the DCI indicates whether the UE is allowed to multiplex the HARQ feedback with other data on the one or more resources. In some implementations, the UE, the processor, and the method may further be configured to, capable of, or operable to receive second DCI that indicates transmission of a transport block (TB) and whether a HARQ process for the TB or for a previous TB is aborted.

An NE (e.g., a base station) for wireless communication is described. The NE may be configured to, capable of, or operable to perform one or more operations as described herein. For example, the NE may be configured to, capable of, or operable to transmit DCI that indicates one or more resources for uplink transmission of HARQ feedback associated with a downlink transmission, and receive the HARQ feedback on a resource of the one or more resources based on the DCI.

A processor (e.g., a standalone processor chipset, or a component of an NE) for wireless communication is described. The processor may be configured to, capable of, or operable to perform one or more operations as described herein. For example, the processor may be configured to, capable of, or operable to transmit DCI that indicates one or more resources for uplink transmission of HARQ feedback associated with a downlink transmission, and receive the HARQ feedback on a resource of the one or more resources based on the DCI.

A method performed or performable by an NE (e.g., a base station) for wireless communication is described. The method may include transmitting DCI that indicates one or more resources for uplink transmission of HARQ feedback associated with a downlink transmission, and receiving the HARQ feedback on a resource of the one or more resources based on the DCI.

In some implementations of the NE, the processor, and the method described herein, the DCI includes a field that indicates which of the one or more resources a UE is to use for the uplink transmission of the HARQ feedback. In some implementations, the DCI indicates a threshold time after reception of the DCI or reception of a PDSCH transmission until which a UE is to transmit the HARQ feedback.

In some implementations, the DCI indicates to transmit the HARQ feedback on a resource associated with a PUSCH, where the resource is at least a number of time units after reception of the DCI or reception of a PDSCH transmission. In some implementations, the NE, the processor, and the method may further be configured to, capable of, or operable to receive an SR or a RACH transmission in response to the resource that is at least the number of time units after the reception of the DCI or the reception of the PDSCH transmission being unavailable.

### BRIEF DESCRIPTION OF THE DRAWINGS

FIG. 1 illustrates an example of a wireless communications system in accordance with aspects of the present disclosure.

FIG. 2 illustrates an example of a signaling diagram in accordance with aspects of the present disclosure.

FIG. 3 illustrates an example of a UE in accordance with aspects of the present disclosure.

FIG. 4 illustrates an example of a processor in accordance with aspects of the present disclosure.

FIG. 5 illustrates an example of an NE in accordance with aspects of the present disclosure.

FIG. 6 illustrates a flowchart of a method performed by a UE in accordance with aspects of the present disclosure.

FIG. 7 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. For example, in a 5G system and other systems beyond 5G (e.g., 6G systems), the UE and the NE may communicate downlink and uplink transmissions. Such transmissions may use (e.g., employ, apply, execute) a number of HARQ processes with incremental redundancy for retransmissions in case a receiver (e.g., the UE) incorrectly receives a TB. As used herein, HARQ may refer to a combination of forward error correction and automatic repeat request (ARQ) protocols that enable a receiver to request retransmission of data that was not successfully decoded. A HARQ process may refer to a logical entity (e.g., implemented as electronic hardware, firmware, software, or combinations of hardware, firmware, or software within the UE) that manages the transmission and retransmission of a particular TB, with each HARQ process being identified by a HARQ process ID. For downlink transmissions, for example, the NE may expect the UE to transmit acknowledgment (ACK) or negative acknowledgment (NACK) feedback for each transmission and retransmission of a TB (e.g. a data block), where an ACK may indicate that the UE successfully decoded the received TB and a NACK may indicate that the UE was unable to successfully decode the received TB. If the NE receives a NACK from the UE, the NE may continue by transmitting a scheduled retransmission of the TB. Alternatively, if the NE receives an ACK from the UE, the NE may use a corresponding HARQ process to transmit a new TB. In such cases, a toggled new data indicator (NDI) in DCI transmitted by the NE and received by the UE may inform the UE of the new TB.

However, in some cases, NACK-to-ACK errors may occur in which the NE incorrectly decodes NACK feedback transmitted by the UE as an ACK. Such errors may result in data loss, as the NE may prematurely initiate processing (e.g., schedule, assign, transmit) a new TB without successfully transmitting the previous TB to the UE. Additionally, DCI may fail to indicate a specific resource for the HARQ feedback transmission, and configured uplink grants may be configured and indicated for a PUSCH transmission, not explicitly for HARQ feedback. To support transmission of a HARQ feedback report on a PUSCH for improved reliability and reduced error (i.e., in particular, reduced NACK-to-ACK errors), the described techniques support managing (e.g., determining, identifying, indicating, and the like) resources for the uplink transmission of HARQ feedback.

As described herein, to reduce HARQ feedback errors and improve transmission reliability, an NE may transmit DCI to a UE that indicates one or more resources for uplink transmission of HARQ feedback associated with a downlink transmission. In some examples, the DCI may include various fields that indicate specific resources, a timing of the HARQ feedback transmission, or other information associated with the transmission of the HARQ feedback. Based on the DCI, the UE may determine a resource of the one or more resources for the uplink transmission of the HARQ feedback. For example, if the DCI includes a field explicitly indicating the resource, the UE may determine to use that resource for the HARQ feedback transmission. Based on receiving the downlink transmission, the UE may transmit the HARQ feedback on the indicated and determined resource.

By performing the described techniques, a device (e.g., a UE and/or an NE) in a wireless communications system may provide for improved HARQ feedback transmission reliability, reduced NACK-to-ACK errors, and enhanced resource utilization for uplink transmissions. For example, an NE may transmit DCI that indicates one or more resources for uplink transmission of HARQ feedback associated with a downlink transmission, enabling the UE to use a specific resource for the HARQ feedback transmission. Such a resource indication may reduce ambiguity and improve the reliability of HARQ feedback delivery compared to other approaches where configured uplink grants are not specifically tied to HARQ feedback. Additionally, the DCI may include timing information that indicates whether to transmit the HARQ feedback on a PUCCH or a PUSCH, which may provide dynamic flexibility in selecting the appropriate channel based on current conditions (e.g., radio channel conditions such as signal-to-noise ratio (SNR) interference levels, or pathloss, traffic loads, a size of a HARQ feedback payload, and the like). For example, the timing information may indicate a short time to allow for a quick turnaround if a low-latency packet delivery is desired or if channel conditions or favorable, or the timing information may indicate a long time if packet delivery is not time-critical and reliability of the HARQ feedback is more important. The techniques may also support multiplexing of HARQ feedback with other data on the MAC level (e.g., within a TB) and on the indicated resources, improving resource efficiency. In addition, the described techniques may support protection of the HARQ feedback transmission (e.g., using a forward error correction code or using a CRC with or without a forward error correction code), enabling error detection and further reducing the likelihood of NACK-to-ACK errors that could otherwise result in data loss.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

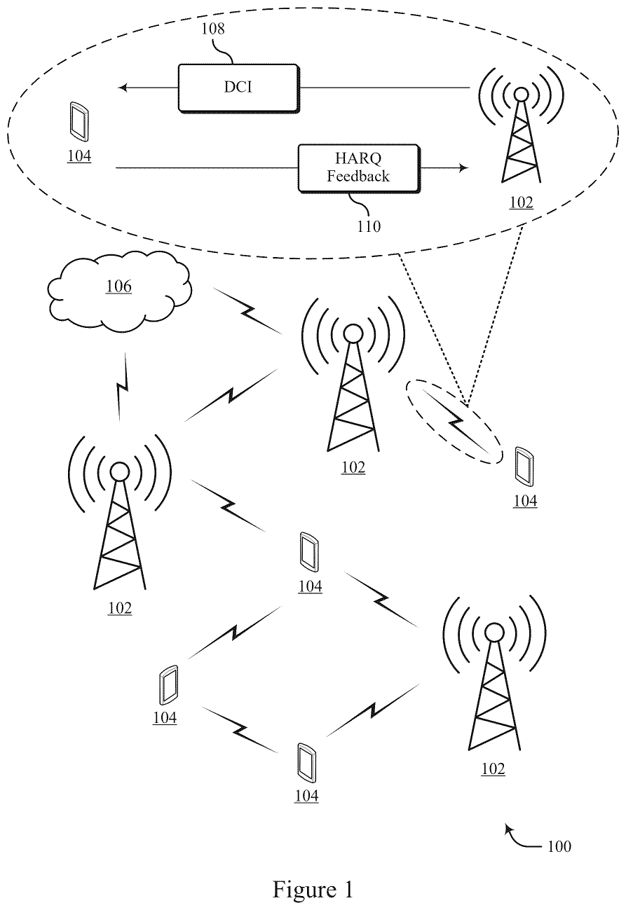

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be movable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or a machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2,μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, an NE 102 may transmit DCI 108 to the UE 104, where the DCI indicates one or more resources for uplink transmission of HARQ feedback 110 associated with a downlink transmission. In some examples, the DCI 108 may include various fields that indicate specific resources, a timing of the HARQ feedback transmission, or other information associated with the transmission of the HARQ feedback. Based on the DCI 108, the UE 104 may determine a resource of the one or more resources for the uplink transmission of the HARQ feedback 110. For example, if the DCI 108 includes a field explicitly indicating the resource, the UE 104 may determine to use that resource for the transmission of the HARQ feedback 110. Based on receiving the downlink transmission, the UE may transmit the HARQ feedback 110 on the indicated and determined resource.

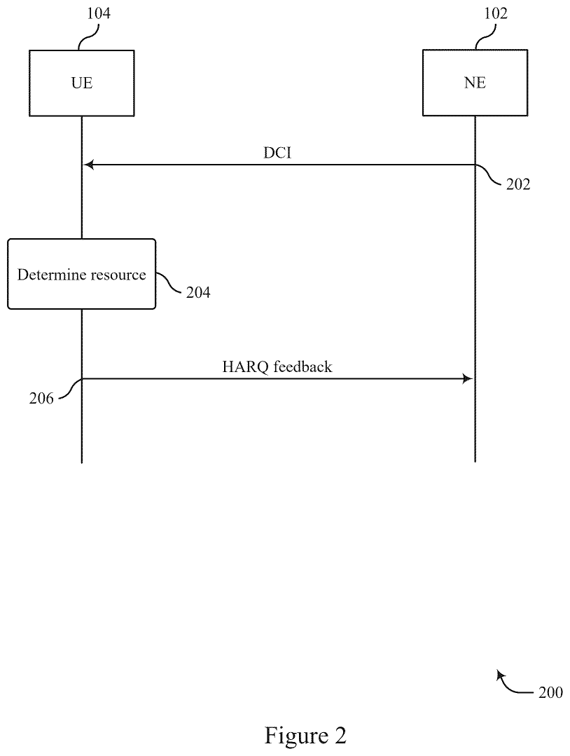

FIG. 2 illustrates an example of a signaling diagram 200 in accordance with aspects of the present disclosure. In some examples, the signaling diagram 200 implements or is implemented by aspects of the wireless communications system 100. The signaling diagram 200 may implement or be implemented by NE 102 and UE 104, which may be examples of the corresponding devices as described with reference to FIG. 1. Alternative examples of the following may be implemented, where some processes are performed in a different order than described or are not performed. In some cases, processes may include additional features not mentioned below, or further processes may be added.

At 202, the NE 102 may transmit DCI to the UE 104. The DCI may be an example of the DCI 108 described herein with reference to FIG. 1. The DCI indicates one or more resources (e.g., PUSCH resources) for uplink transmission of HARQ feedback associated with a downlink transmission. In some examples, the NE 102 may transmit the DCI via a physical downlink control channel (PDCCH). Alternatively, the NE 102 may indicate the one or more resources via a radio resource control (RRC) configuration.

In some implementations, the NE 102 may configure multiple resources (e.g., uplink resources) for the UE 104 and indicate to the UE 104, in the DCI, whether the UE 104 is to use one of the multiple resources for the HARQ feedback transmission, and if so, which of the multiple resources to use. In some such cases, the DCI may also schedule a downlink data transmission for which the UE 104 is to transmit the HARQ feedback. As there may be cases where the UE 104 is to transmit a different number of HARQ feedback bits (e.g., corresponding to multiple HARQ processes or multiple TBs), the corresponding HARQ feedback payload may not be known at the time the NE 102 configures the resources for the HARQ feedback transmission. Additionally, or alternatively, radio channel conditions may fluctuate dynamically such that a slowly configurable resource for the HARQ feedback transmission may provide inefficient or insufficient resources for an error-free transmission of the HARQ feedback. Accordingly, the NE 102 may configure the multiple resources (or multiple resources configurations), and the NE 102 may flexibly select and indicate one or more particular resources to the UE 104.

In some implementations, the DCI may include a field that indicates which of the one or more resources to use for the uplink transmission of the HARQ feedback. For example, the DCI may explicitly indicate a resource (e.g., by a resource index) that the UE 104 is to use for the HARQ feedback transmission. Additionally, or alternatively, the DCI may indicate whether and when the HARQ feedback should be transmitted, in some cases, by including timing information for the uplink transmission of the HARQ feedback. In some cases, for example, the DCI may indicate a threshold (e.g., maximum) time after reception of the DCI or reception of a PDSCH transmission until (e.g., up to) which the UE 104 is to transmit the HARQ feedback. That is, the DCI may indicate a maximum allowed time for the UE to wait for available resources (e.g., PUSCH resources), which may be scheduled by a DCI received later than the DCI scheduling the downlink transmission. The UE 104 may transmit an SR or a RACH message to the NE 102 to obtain such a resource. The UE 104 may transmit an SR or a RACH message to the NE 102 if no transmission opportunity is available within the determined and indicated threshold time.

Additionally, or alternatively, the DCI may indicate whether to transmit the HARQ feedback according to an indicated or determined timing, such as a first timing on a PUCCH or a second timing on a PUSCH. For example, the DCI may indicate to transmit the HARQ feedback on a next available PUSCH resource that is available at least a number of time units (e.g., slots, symbols, subframes, etc.) after the reception of the DCI or reception of a PDSCH. If no such transmission opportunity is available, the UE 104 may transmit an SR or a RACH transmission to obtain resources for the HARQ transmission. In some cases (e.g., based on an indication or configuration by the NE 102), the UE 104 may transmit the SR or RACH only if the pending HARQ feedback includes an ACK, where the NE assumes the HARQ feedback would instead be a NACK if the NE received no feedback from the UE, or if the pending HARQ feedback includes a NACK, where the NE assumes the HARQ feedback would instead be an ACK if the NE received no feedback from the UE. As such, the NE may limit radio resource usage for transmission of an SR or a RACH in case the NE would assume or expect a NACK or an ACK, respectively, if no feedback from the UE is received. Additionally, or alternatively, the DCI may indicate whether to transmit the HARQ feedback on a PUCCH or a PUSCH. The indication of whether to transmit the HARQ feedback on a PUCCH or a PUSCH may be included in timing information indicated in the DCI.

Additionally, or alternatively, the DCI may indicate whether the UE 104 is to protect the uplink transmission of the HARQ feedback by adding a checksum, such as a forward error correction code or a CRC (e.g., with or without a forward error correction code). For example, if the DCI indicates to protect the HARQ feedback transmission using a CRC, the DCI may also indicate (e.g., as configured or defined by the NE 102), a length of the CRC (i.e., a number of CRC bits).

In some implementations, the UE 104 may be limited to a subset of LCHs or LCGs that the UE 104 may multiplex or transmit in a given uplink resource. For example, the UE 104 may be limited to multiplexing or transmitting only medium access control (MAC) control elements (MAC CEs) in a TB that the UE 104 transmits using an uplink resource. In such cases, the NE 102 may configure or indicate such limitations to the UE 104. For example, the DCI may indicate that the one or more resources support transmission of one or more LCHs or one or more LCGs. Such limitations may ensure that regardless of other defined traffic priorities, the indicated resources are exclusively or primarily available for the transmission of the HARQ feedback. In some implementations, the DCI may indicate whether such a limitation on the usage of the indicated one or more resources is applicable or not. For example, the DCI may indicate specific time instances, such as slots, symbols, or subframes, in which the limitation is applicable. For example, the UE 104 may multiplex particular LCGs only in some slots but not others. In some implementations, the DCI that indicates whether such limitations are applicable may be the same DCI that indicates the one or more resources for transmission of the HARQ feedback or a different DCI.

In some implementations, the UE 104 may be capable of multiplexing the HARQ feedback with other data. In such cases, the UE 104 may map the HARQ feedback (e.g., included in a MAC CE) to the beginning of a TB, which may allow for early processing of the HARQ feedback at the receiver (e.g., the NE 102) and facilitate a short turn-around time for retransmissions of the data associated with the HARQ feedback (e.g., if the HARQ feedback includes a NACK). Alternatively, in cases where the UE 104 multiplexes the HARQ feedback with other data, the UE 104 may map the HARQ feedback (e.g., included in a MAC CE) to the end of a TB, which may provide the UE 104 with additional processing time to generate HARQ feedback for multiple downlink transmissions and may facilitate resource-efficient HARQ feedback transmissions. In such cases, the DCI may indicate whether the UE is allowed to multiplex the HARQ feedback with other data on the one or more resources. The DCI that indicates whether the UE is allowed to multiplex the HARQ feedback with other data may be the same DCI that indicates the one or more resources for transmission of the HARQ feedback or a different DCI.

In some examples, the NE 102 may transmit, to the UE 104, second DCI that indicates transmission of a TB and whether a HARQ process (e.g., a HARQ protocol) for the TB or a previous (e.g., earlier) TB is aborted. The second DCI may include various types of indications related to HARQ process management. For example, the second DCI may indicate that the transmission of a TB is a last HARQ transmission of the TB corresponding to a HARQ process. In such cases, the UE 104 may determine, in some cases by checking for a non-toggled NDI, that the UE 104 is not expected to transmit HARQ feedback for the corresponding TB transmission. The NDI is a field in the second DCI that may indicate whether the TB is a new transmission or a retransmission. A toggled NDI may indicate a new TB, and a non-toggled NDI may indicate a retransmission of a previous TB.

Additionally, or alternatively, the second DCI may indicate that the NE 102 aborted a TB that the NE 102 previously transmitted using an indicated HARQ process. In such implementations, the UE 104 may infer from such information, and in some cases from a toggled NDI, that the TB indicated by the second DCI is a new TB, and that the UE 104 may discard the previous content of a corresponding HARQ buffer (e.g., a memory location at the UE 104 that stores information from previous transmissions of a TB to enable soft combining with subsequent retransmissions). In some cases, the indication that the previous (e.g., earlier) TB transmission associated with the HARQ process is aborted may imply that the UE 104 is not expected to generate a HARQ failure report for the aborted TB, which may indicate that a TB could not be successfully decoded after a threshold (e.g., maximum) number of retransmissions. In some implementations, the UE 104 may infer from the indication that the previous TB transmission associated with the HARQ process is aborted, and in some cases from a toggled NDI, that the UE 104 should trigger a higher-layer retransmission of a TB (e.g., a data block) corresponding to the aborted TB. For example, the UE 104 may trigger a Radio Link Control (RLC) retransmission. In some examples, the NDI may be extended, or an explicit bit may be used in the second DCI, to indicate an abort signaling for a certain HARQ process ID, at least for the HARQ process indicated in the second DCI. If the HARQ process is indicated as aborted and the NDI is toggled, the UE 104 may discard information associated with the previous TB, such that no anomaly needs to be reported, and the UE 104 may flush the soft buffer associated with the HARQ process. Alternatively, if the HARQ process is indicated as aborted and the NDI is not toggled, the UE 104 may attempt to decode or soft combine the received transmission but may refrain from reporting further HARQ feedback for the TB. In some examples, a HARQ process associated with TB transmissions may have incremental redundancy, which may involve the NE 102 transmitting additional parity bits or coded bits in each retransmission. The UE 104 may combine the additional bits with previously received bits to improve the likelihood of successful decoding of the TB.

In some implementations, the techniques described herein related to the second DCI may be applied in conjunction with discontinuous reception (DRX) or discontinuous transmission (DTX) operations. DRX is a power-saving mechanism that allows the UE 104 to periodically enter a sleep state when not actively receiving data, while DTX is a corresponding mechanism for transmission. In such implementations, a HARQ feedback transmission time (e.g., the time at which the UE 104 transmits a HARQ control element (CE) including the HARQ feedback) may serve as a reference point for DRX retransmission time handling. Additionally, the transmission of the HARQ feedback (e.g., via a MAC CE) may be allowed as an exception when connected-mode DRX (C-DRX) is in an active or ON state. The NE 102 may control this exception on a per-TB or per-HARQ process basis, for example, depending on whether particular (e.g., important) information is included in the TB. C-DRX refers to the DRX operation when the UE 104 is in a connected state with the NE 102, allowing the UE 104 to conserve power while maintaining the connection.

At 204, based on the DCI, the UE 104 may determine (e.g., identify, select) a resource of the one or more resources for the uplink transmission of the HARQ feedback. For example, if the DCI includes a field that indicates which of the one or more resources to use for the uplink transmission of the HARQ feedback, the UE 104 may determine the resource based on the field. In some examples, the UE 104 may determine the resource of the one or more resources only if the UE 104 has HARQ feedback associated with a downlink transmission to transmit to the NE 102 (e.g., in response to receiving the downlink transmission). Otherwise, if the UE 104 lacks HARQ feedback, the UE 104 may skip the one or more resources indicated in the DCI. In this way, the UE 104 may only use the one or more resources for transmitting the HARQ feedback, which may be multiplexed with other data in some cases, and refrain from using the one or more resources for transmissions without HARQ feedback. This may enable the NE to configure identical resources for multiple UEs while also ensuring that only one of the UEs utilizes the resource(s) based on appropriate indication and scheduling by DCI.

At 206, the UE 104 may transmit the HARQ feedback to the NE 102 on the determined resource. In some implementations, the UE 104 may map bits of the HARQ feedback to a subset of bits of a modulation symbol and transmit the HARQ feedback using one or more bits based on the mapping. That is, the UE 104 may map the bits pertaining to (e.g., associated with, configured for) the HARQ feedback to a subset of bits of a modulation symbol that have a higher error resilience than other bits of a modulation symbol. For example, in a modulation symbol employing 16-quadrature amplitude modulation (QAM), which allows four bits (e.g., b₁b₂b₃b₄) to be transmitted in one symbol, two bits, b₁ and b₂, may have a higher error resilience than the other two bits. In such cases, the UE 104 may transmit the HARQ feedback using the first two bits, b₁ and b₂, and transmit other information (e.g., associated with user data) using the other two bits, b₃ and b₄.

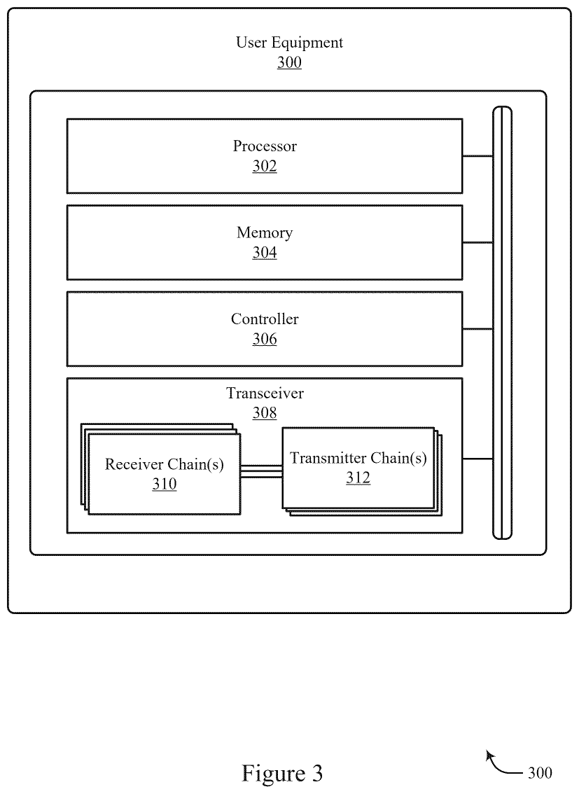

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof, configured as or otherwise supporting a means for performing the functions described in the present disclosure.

The processor 302 may include an intelligent hardware device (e.g., a general-purpose processor, a DSP, a CPU, an ASIC, an FPGA, or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions that, when executed by the processor 302, cause the UE 300 to perform various functions described herein. The code may be stored in a non-transitory computer-readable medium such as the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the functions described herein (e.g., executing, by the processor 302, instructions stored in the memory 304). For example, the processor 302 may support wireless communication at the UE 300 in accordance with examples as disclosed herein. The UE 300 may be configured to or be operable to support a means for receiving DCI that indicates one or more resources for uplink transmission of HARQ feedback associated with a downlink transmission, determining a resource of the one or more resources for the uplink transmission of the HARQ feedback based on the DCI, and transmitting the HARQ feedback on the resource of the one or more resources. In this manner, the UE 300 supports improved HARQ feedback transmission reliability, reduced NACK-to-ACK errors, and enhanced resource utilization for uplink transmissions by enabling explicit resource indication for HARQ feedback delivery.

Additionally, the UE 300 may be configured to support any one or combination of the following. For example, the UE 300 may be configured to or be operable to support where the DCI includes a field that indicates which of the one or more resources to use for the uplink transmission of the HARQ feedback, and determining the resource based on the field. This aspect reduces ambiguity in resource selection and improves the reliability of HARQ feedback delivery by providing explicit resource indication. Additionally, or alternatively, the UE 300 may be configured to or be operable to support where the DCI indicates a threshold time after reception of the DCI or reception of a PDSCH transmission until which to transmit the HARQ feedback. This aspect enables flexible timing control for HARQ feedback transmission, improving latency management and ensuring timely feedback delivery. Additionally, or alternatively, the UE 300 may be configured to or be operable to support where the DCI indicates to transmit the HARQ feedback on a resource associated with a PUSCH, where the resource is at least a number of time units after reception of the DCI or reception of a PDSCH transmission. This aspect provides sufficient processing time for the UE to prepare HARQ feedback while ensuring reliable transmission on PUSCH resources. Additionally, or alternatively, the UE 300 may be configured to or be operable to support transmitting an SR or a RACH transmission in response to the resource that is at least the number of time units after the reception of the DCI or the reception of the PDSCH transmission being unavailable. This aspect ensures HARQ feedback can still be transmitted even when indicated resources are unavailable, improving system reliability and preventing data loss due to missed feedback opportunities.

Additionally, or alternatively, the UE 300 may be configured to or be operable to support where the DCI indicates whether to transmit the HARQ feedback on a PUCCH or a PUSCH. This aspect provides dynamic flexibility in selecting the appropriate channel based on current conditions, improving resource efficiency and transmission reliability. Additionally, or alternatively, the UE 300 may be configured to or be operable to support where the DCI includes timing information for the uplink transmission of the HARQ feedback, where the timing information indicates whether to transmit the HARQ feedback on the PUCCH or the PUSCH. This aspect enables coordinated timing and channel selection, reducing signaling overhead and improving transmission efficiency. Additionally, or alternatively, the UE 300 may be configured to or be operable to support where the DCI indicates to protect the uplink transmission of the HARQ feedback by a CRC. This aspect enables error detection and further reduces the likelihood of NACK-to-ACK errors that could otherwise result in data loss, improving transmission reliability. Additionally, or alternatively, the UE 300 may be configured to or be operable to support mapping bits of the HARQ feedback to a subset of bits of a modulation symbol, where the HARQ feedback is transmitted using one or more bits based on the mapping. This aspect improves error resilience of HARQ feedback by utilizing bits with higher error resilience within modulation symbols, reducing NACK-to-ACK error probability. Additionally, or alternatively, the UE 300 may be configured to or be operable to support refraining from using the resource in an absence of the HARQ feedback associated with the downlink transmission. This aspect improves resource efficiency by ensuring indicated resources are used exclusively for HARQ feedback transmission, preventing unnecessary resource consumption.

Additionally, or alternatively, the UE 300 may be configured to or be operable to support where the DCI indicates that the one or more resources support transmission of one or more LCHs or one or more LCGs. This aspect ensures that indicated resources are exclusively or primarily available for HARQ feedback transmission regardless of other defined traffic priorities, improving HARQ feedback delivery reliability. Additionally, or alternatively, the UE 300 may be configured to or be operable to support where the DCI indicates whether the UE is allowed to multiplex the HARQ feedback with other data on the one or more resources. This aspect improves resource efficiency by enabling multiplexing of HARQ feedback with other data when appropriate, optimizing uplink resource utilization. Additionally, or alternatively, the UE 300 may be configured to or be operable to support receiving second DCI that indicates transmission of a TB and whether a HARQ process for the TB or for a previous TB is aborted. This aspect enables efficient HARQ process management by allowing the UE to signal process abortion, reducing unnecessary retransmissions and improving system throughput.

Additionally, or alternatively, the UE 300 may support at least one memory (e.g., the memory 304) and at least one processor (e.g., the processor 302) coupled with the at least one memory and configured to cause the UE to receive DCI that indicates one or more resources for uplink transmission of HARQ feedback associated with a downlink transmission, determine a resource of the one or more resources for the uplink transmission of the HARQ feedback based on the DCI, and transmit the HARQ feedback on the resource of the one or more resources. In this manner, the UE 300 supports improved HARQ feedback transmission reliability, reduced NACK-to-ACK errors, and enhanced resource utilization for uplink transmissions by enabling explicit resource indication for HARQ feedback delivery.

Additionally, the UE 300 may be configured to support any one or combination of the following. For example, the UE 300 may be configured to or be operable to support where the DCI includes a field that indicates which of the one or more resources to use for the uplink transmission of the HARQ feedback, and determining the resource based on the field. This aspect reduces ambiguity in resource selection and improves the reliability of HARQ feedback delivery by providing explicit resource indication. Additionally, or alternatively, the UE 300 may be configured to or be operable to support where the DCI indicates a threshold time after reception of the DCI or reception of a PDSCH transmission until which to transmit the HARQ feedback. This aspect enables flexible timing control for HARQ feedback transmission, improving latency management and ensuring timely feedback delivery. Additionally, or alternatively, the UE 300 may be configured to or be operable to support where the DCI indicates to transmit the HARQ feedback on a resource associated with a PUSCH, where the resource is at least a number of time units after reception of the DCI or reception of a PDSCH transmission. This aspect provides sufficient processing time for the UE to prepare HARQ feedback while ensuring reliable transmission on PUSCH resources. Additionally, or alternatively, the UE 300 may be configured to or be operable to support transmitting an SR or a RACH transmission in response to the resource that is at least the number of time units after the reception of the DCI or the reception of the PDSCH transmission being unavailable. This aspect ensures HARQ feedback can still be transmitted even when indicated resources are unavailable, improving system reliability and preventing data loss due to missed feedback opportunities.

Additionally, or alternatively, the UE 300 may be configured to or be operable to support where the DCI indicates whether to transmit the HARQ feedback on a PUCCH or a PUSCH. This aspect provides dynamic flexibility in selecting the appropriate channel based on current conditions, improving resource efficiency and transmission reliability. Additionally, or alternatively, the UE 300 may be configured to or be operable to support where the DCI includes timing information for the uplink transmission of the HARQ feedback, where the timing information indicates whether to transmit the HARQ feedback on the PUCCH or the PUSCH. This aspect enables coordinated timing and channel selection, reducing signaling overhead and improving transmission efficiency. Additionally, or alternatively, the UE 300 may be configured to or be operable to support where the DCI indicates to protect the uplink transmission of the HARQ feedback by a CRC. This aspect enables error detection and further reduces the likelihood of NACK-to-ACK errors that could otherwise result in data loss, improving transmission reliability. Additionally, or alternatively, the UE 300 may be configured to or be operable to support mapping bits of the HARQ feedback to a subset of bits of a modulation symbol, where the HARQ feedback is transmitted using one or more bits based on the mapping. This aspect improves error resilience of HARQ feedback by utilizing bits with higher error resilience within modulation symbols, reducing NACK-to-ACK error probability. Additionally, or alternatively, the UE 300 may be configured to or be operable to support refraining from using the resource in an absence of the HARQ feedback associated with the downlink transmission. This aspect improves resource efficiency by ensuring indicated resources are used exclusively for HARQ feedback transmission, preventing unnecessary resource consumption.

Additionally, or alternatively, the UE 300 may be configured to or be operable to support where the DCI indicates that the one or more resources support transmission of one or more LCHs or one or more LCGs. This aspect ensures that indicated resources are exclusively or primarily available for HARQ feedback transmission regardless of other defined traffic priorities, improving HARQ feedback delivery reliability. Additionally, or alternatively, the UE 300 may be configured to or be operable to support where the DCI indicates whether the UE is allowed to multiplex the HARQ feedback with other data on the one or more resources. This aspect improves resource efficiency by enabling multiplexing of HARQ feedback with other data when appropriate, optimizing uplink resource utilization. Additionally, or alternatively, the UE 300 may be configured to or be operable to support receiving second DCI that indicates transmission of a TB and whether a HARQ process for the TB or for a previous TB is aborted. This aspect enables efficient HARQ process management by allowing the NE to signal process abortion, reducing unnecessary retransmissions and improving system throughput.

The controller 306 may manage input and output signals for the UE 300. The controller 306 may also manage peripherals not integrated into the UE 300. In some implementations, the controller 306 may utilize an operating system such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas to receive a signal over the air or wireless medium. The receiver chain 310 may include at least one amplifier (e.g., a low-noise amplifier (LNA)) configured to amplify the received signal. The receiver chain 310 may include at least one demodulator configured to demodulate the received signal and obtain the transmitted data by reversing the modulation technique applied during transmission of the signal. The receiver chain 310 may include at least one decoder for decoding the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or QAM. The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

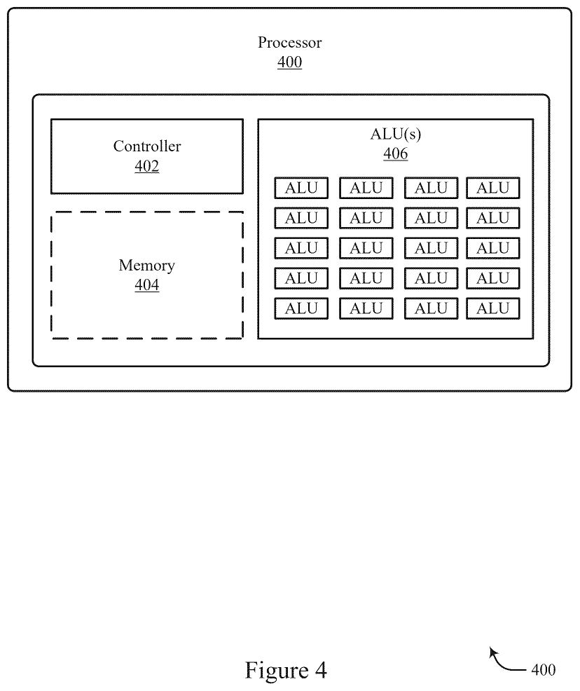

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may include at least one memory 404, which may be, for example, an L1/L2/L3 cache. Additionally, or alternatively, the processor 400 may include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory addresses of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, ALUs 406, and other functional units of the processor 400.

The memory 404 may include one or more caches (e.g., memory local to or included in the processor 400 or other memory, such as RAM, ROM, DRAM, SDRAM, SRAM, MRAM, flash memory, etc.). In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, and the controller 402, and may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 may be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

The processor 400 may support wireless communication in accordance with examples as disclosed herein. The processor 400 may be configured to or be operable to support at least one controller (e.g., the controller 402) coupled with at least one memory (e.g., the memory 404) and configured to cause the processor to receive DCI that indicates one or more resources for uplink transmission of HARQ feedback associated with a downlink transmission, determine a resource of the one or more resources for the uplink transmission of the HARQ feedback based on the DCI, and transmit the HARQ feedback on the resource of the one or more resources. In this manner, the processor 400 supports improved HARQ feedback transmission reliability, reduced NACK-to-ACK errors, and enhanced resource utilization for uplink transmissions by enabling explicit resource indication for HARQ feedback delivery.

Additionally, the processor 400 may be configured to support any one or combination of the following. For example, the processor 400 may be configured to or be operable to support where the DCI includes a field that indicates which of the one or more resources to use for the uplink transmission of the HARQ feedback, and determining the resource based on the field. This aspect reduces ambiguity in resource selection and improves the reliability of HARQ feedback delivery by providing explicit resource indication. Additionally, or alternatively, the processor 400 may be configured to or be operable to support where the DCI indicates a threshold time after reception of the DCI or reception of a PDSCH transmission until which to transmit the HARQ feedback. This aspect enables flexible timing control for HARQ feedback transmission, improving latency management and ensuring timely feedback delivery. Additionally, or alternatively, the processor 400 may be configured to or be operable to support where the DCI indicates to transmit the HARQ feedback on a resource associated with a PUSCH, where the resource is at least a number of time units after reception of the DCI or reception of a PDSCH transmission. This aspect provides sufficient processing time for the UE to prepare HARQ feedback while ensuring reliable transmission on PUSCH resources. Additionally, or alternatively, the processor 400 may be configured to or be operable to support transmitting an SR or a RACH transmission in response to the resource that is at least the number of time units after the reception of the DCI or the reception of the PDSCH transmission being unavailable. This aspect ensures HARQ feedback can still be transmitted even when indicated resources are unavailable, improving system reliability and preventing data loss due to missed feedback opportunities.

Additionally, or alternatively, the processor 400 may be configured to or be operable to support where the DCI indicates whether to transmit the HARQ feedback on a PUCCH or a PUSCH. This aspect provides dynamic flexibility in selecting the appropriate channel based on current conditions, improving resource efficiency and transmission reliability. Additionally, or alternatively, the processor 400 may be configured to or be operable to support where the DCI includes timing information for the uplink transmission of the HARQ feedback, where the timing information indicates whether to transmit the HARQ feedback on the PUCCH or the PUSCH. This aspect enables coordinated timing and channel selection, reducing signaling overhead and improving transmission efficiency. Additionally, or alternatively, the processor 400 may be configured to or be operable to support where the DCI indicates to protect the uplink transmission of the HARQ feedback by a CRC. This aspect enables error detection and further reduces the likelihood of NACK-to-ACK errors that could otherwise result in data loss, improving transmission reliability. Additionally, or alternatively, the processor 400 may be configured to or be operable to support mapping bits of the HARQ feedback to a subset of bits of a modulation symbol, where the HARQ feedback is transmitted using one or more bits based on the mapping. This aspect improves error resilience of HARQ feedback by utilizing bits with higher error resilience within modulation symbols, reducing NACK-to-ACK error probability. Additionally, or alternatively, the processor 400 may be configured to or be operable to support refraining from using the resource in an absence of the HARQ feedback associated with the downlink transmission. This aspect improves resource efficiency by ensuring indicated resources are used exclusively for HARQ feedback transmission, preventing unnecessary resource consumption.

Additionally, or alternatively, the processor 400 may be configured to or be operable to support where the DCI indicates that the one or more resources support transmission of one or more LCHs or one or more LCGs. This aspect ensures that indicated resources are exclusively or primarily available for HARQ feedback transmission regardless of other defined traffic priorities, improving HARQ feedback delivery reliability. Additionally, or alternatively, the processor 400 may be configured to or be operable to support where the DCI indicates whether the UE is allowed to multiplex the HARQ feedback with other data on the one or more resources. This aspect improves resource efficiency by enabling multiplexing of HARQ feedback with other data when appropriate, optimizing uplink resource utilization. Additionally, or alternatively, the processor 400 may be configured to or be operable to support receiving second DCI that indicates transmission of a TB and whether a HARQ process for the TB or for a previous TB is aborted. This aspect enables efficient HARQ process management by allowing the NE to signal process abortion, reducing unnecessary retransmissions and improving system throughput.

Additionally, or alternatively, the processor 400 may support wireless communication in accordance with examples as disclosed herein. The processor 400 may be configured to or be operable to support at least one controller (e.g., the controller 402) coupled with at least one memory (e.g., the memory 404) and configured to cause the processor to transmit DCI that indicates one or more resources for uplink transmission of HARQ feedback associated with a downlink transmission, and receive the HARQ feedback on a resource of the one or more resources based on the DCI. In this manner, the processor 400 supports improved HARQ feedback reception reliability, reduced NACK-to-ACK errors, and enhanced resource utilization by enabling explicit resource indication for HARQ feedback delivery.

Additionally, the processor 400 may be configured to or be operable to support any one or combination of the following. For example, the processor 400 may be configured to or be operable to support where the DCI includes a field that indicates which of the one or more resources a UE is to use for the uplink transmission of the HARQ feedback. This aspect reduces ambiguity in resource selection and improves the reliability of HARQ feedback reception by providing explicit resource indication to the UE. Additionally, or alternatively, the processor 400 may be configured to or be operable to support where the DCI indicates a threshold time after reception of the DCI or reception of a PDSCH transmission until which a UE is to transmit the HARQ feedback. This aspect enables flexible timing control for HARQ feedback reception, improving latency management and ensuring timely feedback delivery at the NE.

Additionally, or alternatively, the processor 400 may be configured to or be operable to support where the DCI indicates to transmit the HARQ feedback on a resource associated with a PUSCH, where the resource is at least a number of time units after reception of the DCI or reception of a PDSCH transmission. This aspect provides sufficient processing time for the UE to prepare HARQ feedback while ensuring reliable reception on PUSCH resources at the NE. Additionally, or alternatively, the processor 400 may be configured to or be operable to support receiving an SR or a RACH transmission in response to the resource that is at least the number of time units after the reception of the DCI or the reception of the PDSCH transmission being unavailable. This aspect ensures HARQ feedback can still be received even when indicated resources are unavailable, improving system reliability and preventing data loss due to missed feedback opportunities.

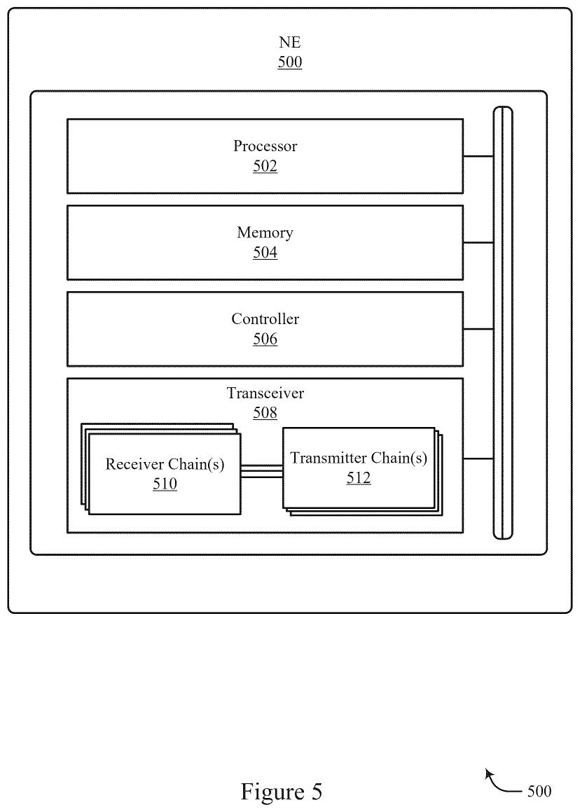

FIG. 5 illustrates an example of an NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions that, when executed by the processor 502, cause the NE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the functions described herein (e.g., executing, by the processor 502, instructions stored in the memory 504). For example, the processor 502 may support wireless communication at the NE 500 in accordance with examples as disclosed herein. The NE 500 may be configured to or be operable to support a means for transmitting DCI that indicates one or more resources for uplink transmission of HARQ feedback associated with a downlink transmission, and receiving the HARQ feedback on a resource of the one or more resources based on the DCI. In this manner, the NE 500 supports improved HARQ feedback reception reliability, reduced NACK-to-ACK errors, and enhanced resource utilization by enabling explicit resource indication for HARQ feedback delivery.

Additionally, the NE 500 may be configured to or be operable to support any one or combination of the following. For example, the NE 500 may be configured to or be operable to support where the DCI includes a field that indicates which of the one or more resources a UE is to use for the uplink transmission of the HARQ feedback. This aspect reduces ambiguity in resource selection and improves the reliability of HARQ feedback reception by providing explicit resource indication to the UE. Additionally, or alternatively, the NE 500 may be configured to or be operable to support where the DCI indicates a threshold time after reception of the DCI or reception of a PDSCH transmission until which a UE is to transmit the HARQ feedback. This aspect enables flexible timing control for HARQ feedback reception, improving latency management and ensuring timely feedback delivery at the NE.

Additionally, or alternatively, the NE 500 may be configured to or be operable to support where the DCI indicates to transmit the HARQ feedback on a resource associated with a PUSCH, where the resource is at least a number of time units after reception of the DCI or reception of a PDSCH transmission. This aspect provides sufficient processing time for the UE to prepare HARQ feedback while ensuring reliable reception on PUSCH resources at the NE. Additionally, or alternatively, the NE 500 may be configured to or be operable to support receiving an SR or a RACH transmission in response to the resource that is at least the number of time units after the reception of the DCI or the reception of the PDSCH transmission being unavailable. This aspect ensures HARQ feedback can still be received even when indicated resources are unavailable, improving system reliability and preventing data loss due to missed feedback opportunities.

Additionally, or alternatively, the NE 500 may support at least one memory (e.g., the memory 504) and at least one processor (e.g., the processor 502) coupled with the at least one memory and configured to cause the NE to transmit DCI that indicates one or more resources for uplink transmission of HARQ feedback associated with a downlink transmission, and receive the HARQ feedback on a resource of the one or more resources based on the DCI. In this manner, the NE 500 supports improved HARQ feedback reception reliability, reduced NACK-to-ACK errors, and enhanced resource utilization by enabling explicit resource indication for HARQ feedback delivery.

Additionally, the NE 500 may be configured to or be operable to support any one or combination of the following. For example, the NE 500 may be configured to or be operable to support where the DCI includes a field that indicates which of the one or more resources a UE is to use for the uplink transmission of the HARQ feedback. This aspect reduces ambiguity in resource selection and improves the reliability of HARQ feedback reception by providing explicit resource indication to the UE. Additionally, or alternatively, the NE 500 may be configured to or be operable to support where the DCI indicates a threshold time after reception of the DCI or reception of a PDSCH transmission until which a UE is to transmit the HARQ feedback. This aspect enables flexible timing control for HARQ feedback reception, improving latency management and ensuring timely feedback delivery at the NE.

Additionally, or alternatively, the NE 500 may be configured to or be operable to support where the DCI indicates to transmit the HARQ feedback on a resource associated with a PUSCH, where the resource is at least a number of time units after reception of the DCI or reception of a PDSCH transmission. This aspect provides sufficient processing time for the UE to prepare HARQ feedback while ensuring reliable reception on PUSCH resources at the NE. Additionally, or alternatively, the NE 500 may be configured to or be operable to support receiving an SR or a RACH transmission in response to the resource that is at least the number of time units after the reception of the DCI or the reception of the PDSCH transmission being unavailable. This aspect ensures HARQ feedback can still be received even when indicated resources are unavailable, improving system reliability and preventing data loss due to missed feedback opportunities.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like PSK or QAM. The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

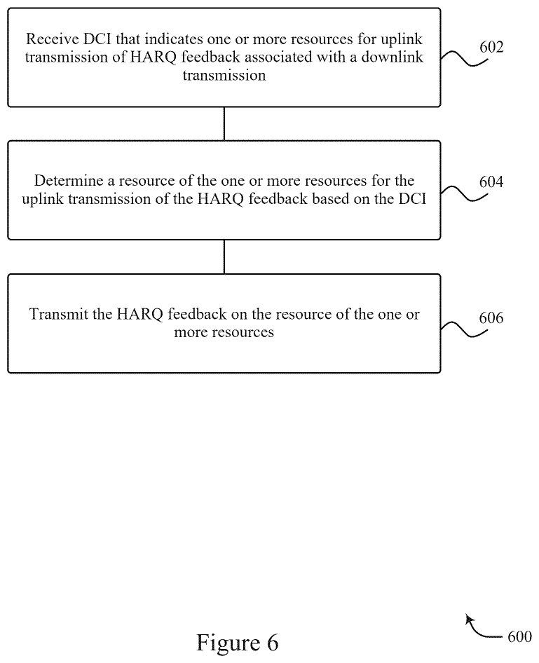

FIG. 6 illustrates a flowchart of a method 600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 602, the method may include receiving DCI that indicates one or more resources for uplink transmission of HARQ feedback associated with a downlink transmission. The operations of 602 may be performed in accordance with examples as described herein. In some implementations, aspects of the operations of 602 may be performed by a UE as described with reference to FIG. 3.

At 604, the method may include determining a resource of the one or more resources for the uplink transmission of the HARQ feedback based on the DCI. The operations of 604 may be performed in accordance with examples as described herein. In some implementations, aspects of the operations of 604 may be performed by a UE as described with reference to FIG. 3.

At 606, the method may include transmitting the HARQ feedback on the resource of the one or more resources. The operations of 606 may be performed in accordance with examples as described herein. In some implementations, aspects of the operations of 606 may be performed by a UE as described with reference to FIG. 3.

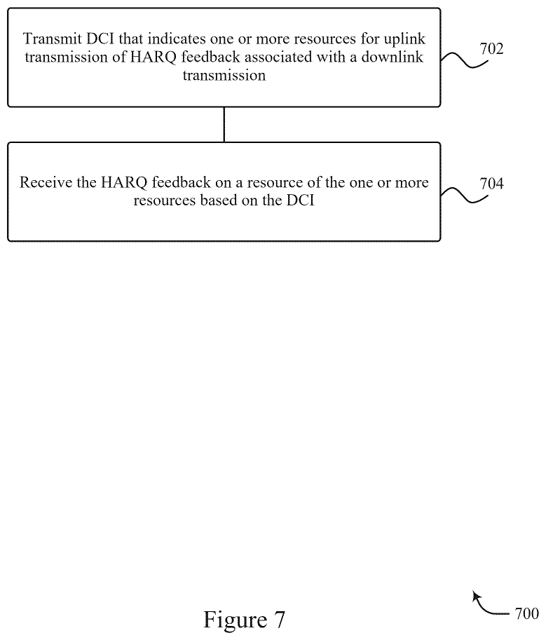

FIG. 7 illustrates a flowchart of a method 700 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 702, the method may include transmitting DCI that indicates one or more resources for uplink transmission of HARQ feedback associated with a downlink transmission. The operations of 702 may be performed in accordance with examples as described herein. In some implementations, aspects of the operations of 702 may be performed by an NE as described with reference to FIG. 5.

At 704, the method may include receiving the HARQ feedback on a resource of the one or more resources based on the DCI. The operations of 704 may be performed in accordance with examples as described herein. In some implementations, aspects of the operations of 704 may be performed by an NE as described with reference to FIG. 5.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively operable to cause the UE to:
receive downlink control information (DCI) that indicates one or more resources for uplink transmission of hybrid automatic repeat request (HARQ) feedback associated with a downlink transmission;
determine a resource of the one or more resources for the uplink transmission of the HARQ feedback based at least in part on the DCI; and
transmit the HARQ feedback on the resource of the one or more resources.

2. The UE of claim 1, wherein the DCI includes a field that indicates which of the one or more resources to use for the uplink transmission of the HARQ feedback, and wherein the one or more processors are further individually or collectively operable to cause the UE to: determine the resource based at least in part on the field.

3. The UE of claim 1, wherein the DCI indicates a threshold time after reception of the DCI or reception of a physical downlink shared channel (PDSCH) transmission until which to transmit the HARQ feedback.

4. The UE of claim 1, wherein the DCI indicates to transmit the HARQ feedback on a resource associated with a physical uplink shared channel (PUSCH), wherein the resource is at least a number of time units after reception of the DCI or reception of a physical downlink shared channel (PDSCH) transmission.

5. The UE of claim 4, wherein the one or more processors are further individually or collectively operable to cause the UE to: transmit a scheduling request (SR) or a random access channel (RACH) transmission in response to the resource that is at least the number of time units after the reception of the DCI or the reception of the PDSCH transmission being unavailable.

6. The UE of claim 1, wherein the DCI indicates whether to transmit the HARQ feedback on a physical uplink control channel (PUCCH) or a physical uplink shared channel (PUSCH).

7. The UE of claim 6, wherein the DCI includes timing information for the uplink transmission of the HARQ feedback, and wherein the timing information indicates whether to transmit the HARQ feedback on the PUCCH or the PUSCH.

8. The UE of claim 1, wherein the DCI indicates to protect the uplink transmission of the HARQ feedback by a cyclic redundancy check (CRC).

9. The UE of claim 1, wherein the one or more processors are further individually or collectively operable to cause the UE to: map bits of the HARQ feedback to a subset of bits of a modulation symbol, and wherein the HARQ feedback is transmitted using one or more bits based at least in part on the mapping.

10. The UE of claim 1, wherein the one or more processors are further individually or collectively operable to cause the UE to: refrain from using the resource in an absence of the HARQ feedback associated with the downlink transmission.

11. The UE of claim 1, wherein the DCI indicates that the one or more resources support transmission of one or more logical channels (LCHs) or one or more logical channel groups (LCGs).

12. The UE of claim 1, wherein the DCI indicates whether the UE is allowed to multiplex the HARQ feedback with other data on the one or more resources.

13. The UE of claim 1, wherein the one or more processors are further individually or collectively operable to cause the UE to: receive second DCI that indicates transmission of a transport block (TB) and whether a HARQ process for the TB or for a previous TB is aborted.

14. A network equipment (NE) for wireless communication, comprising:
one or more memories; and
one or more processors coupled with the one or more memories and individually or collectively operable to cause the NE to:
transmit downlink control information (DCI) that indicates one or more resources for uplink transmission of hybrid automatic repeat request (HARQ) feedback associated with a downlink transmission; and
receive the HARQ feedback on a resource of the one or more resources based at least in part on the DCI.

15. The NE of claim 14, wherein the DCI includes a field that indicates which of the one or more resources a user equipment (UE) is to use for the uplink transmission of the HARQ feedback.

16. The NE of claim 14, wherein the DCI indicates a threshold time after reception of the DCI or reception of a physical downlink shared channel (PDSCH) transmission until which a UE is to transmit the HARQ feedback.

17. The NE of claim 14, wherein the DCI indicates to transmit the HARQ feedback on a resource associated with a physical uplink shared channel (PUSCH), wherein the resource is at least a number of time units after reception of the DCI or reception of a physical downlink shared channel (PDSCH) transmission.

18. The NE of claim 17, wherein the one or more processors are further individually or collectively operable to cause the NE to: receive a scheduling request (SR) or a random access channel (RACH) transmission in response to the resource that is at least the number of time units after the reception of the DCI or the reception of the PDSCH transmission being unavailable.

19. A method performed by a user equipment (UE), the method comprising:
receiving downlink control information (DCI) that indicates one or more resources for uplink transmission of hybrid automatic repeat request (HARQ) feedback associated with a downlink transmission;
determining a resource of the one or more resources for the uplink transmission of the HARQ feedback based at least in part on the DCI; and
transmitting the HARQ feedback on the resource of the one or more resources.

20. A method performed by a network equipment (NE), the method comprising:
transmitting downlink control information (DCI) that indicates one or more resources for uplink transmission of hybrid automatic repeat request (HARQ) feedback associated with a downlink transmission; and
receiving the HARQ feedback on a resource of the one or more resources based at least in part on the DCI.
